(19) United States
(12) Patent Application Publication
(10) Pub. No.: US 2025/0284697 A1
(43) Pub. Date: Sep. 11, 2025

(54) Generation of Applications from Capabilities

(71) Applicant: ServiceNow, Inc., Santa Clara, CA (US)

(72) Inventors: Prashanti Nilayam, Santa Clara, CA (US); Gaurav Goyal, Santa Clara, CA (US)

(21) Appl. No.: 18/596,387

(22) Filed: Mar. 5, 2024

(51) Int. Cl. G06F 16/2457; G06F 16/242

(52) U.S. Cl. CPC G06F 16/24573; G06F 16/2438

(57) ABSTRACT

Systems and methods are provided that include obtaining a user input; obtaining, from a database, data indicative of a plurality of capabilities; identifying, via a machine learning model, a subset of the plurality of capabilities based on the user input; determining a graph representing dependencies regarding the subset of the plurality of capabilities; and generating an application based on an output of the machine learning model and the graph, wherein the application includes the subset of the plurality of capabilities. This results in improved generation and execution of applications composed of multiple capabilities, which can include database table generation, new role creation, and the creation of approval flows. Use of large language models or other generative machine learning models allows the application generation process to be improved, reducing compute and storage requirements and reducing the degree to which user input is required for generation and execution of such applications.

### BACKGROUND

The operation of a managed network or other computerized system can be facilitated by representing commonly-used tasks or operations as capabilities. Representations of the capabilities may be stored in a database. Examples of the capabilities include programs, database storage schemas, access control lists, configuration data, credentialing processes, or other objects that can be executed or used in particular contexts to provide the benefit of the capability. An application can be generated by compositing the capabilities with each other. For example, outputs of some of the capabilities may form inputs to other capabilities. However, specifying all possible applications, even for a small number of capabilities and/or a small maximum number of capabilities per application, is computationally expensive and may be computationally intractable. Further, maintaining all such applications for use and reuse requires significant data storage resources.

### SUMMARY

The embodiments described herein provide improved methods for generating applications via a specific combination of generative machine learning models (e.g., large language models (“LLMs”)) and other methods to generate applications from available capabilities. These embodiments include obtaining user input that describes the functionality and other information about a desired application. This user input can be applied to a generative machine learning model (e.g., to an LLM) along with descriptions of the functionality and method of use (e.g., input/output lists, API call formatting) of a set of available capabilities. The generative model then outputs a representation of which of the available capabilities to use to implement the desired application. The model output can also include a number of times to use each capability, a mapping of information present in the user textual input to inputs or configuration parameters of the capabilities, and other information about the use or configuration of the selected capabilities. A graphing function is then applied to the model output to generate a graph of the selected capabilities based on the relationships between the selected capabilities (e.g., based on the outputs of one capability being input to another, based on the effect of one capability on a database being prerequisite to the operation of another capability).

The embodiments described herein allow applications to be generated in less time using reduced computational resources relative to alternative methods. The methods described herein also allow the applications that are generated to be targeted, within the space of all possible applications for a set of available capabilities, toward more functionally useful applications. This reduces the computational cost of generating the application and the storage cost of maintaining the generated applications for later use or reuse. The use of a model to ‘pre-allocate’ certain inputs to the capabilities selected for an application simplifies the operation of the graphing function, by reducing the number of inputs, outputs, or other dependencies that the graphing function has to satisfy. The computational cost of executing the generative machine learning model can also be reduced by using a semantic search applied to the user textual input in order to pre-select the capabilities from a larger set of possible capabilities (e.g., allowing a model with a shorter maximum input and fewer total parameters to be used).

Accordingly, a first example embodiment may involve a method that includes: (i) obtaining a user input; (ii) obtaining, from a database, data indicative of a plurality of capabilities; (iii) identifying, via a machine learning model, a subset of the plurality of capabilities based on the user input; (iv) determining a graph representing dependencies regarding the subset of the plurality of capabilities; and (v) generating an application based on an output of the machine learning model and the graph, wherein the application includes the subset of the plurality of capabilities.

A second example embodiment may involve a non-transitory computer-readable medium, having stored thereon program instructions that, upon execution by a computing system, cause the computing system to perform operations in accordance with the previous example embodiment.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts a selection of skills, in accordance with example embodiments.

FIG. 6B depicts a connected selection of skills that form an application, in accordance with example embodiments.

FIG. 7 depicts input to and output from an LLM, in accordance with example embodiments.

FIG. 8 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

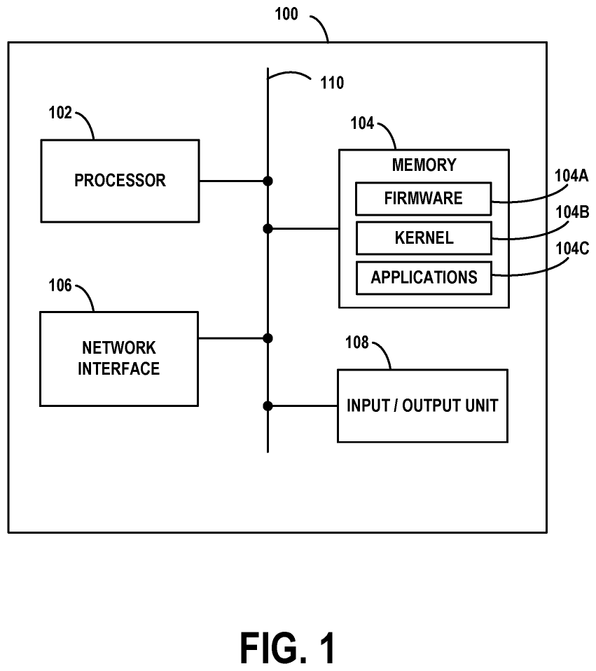

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

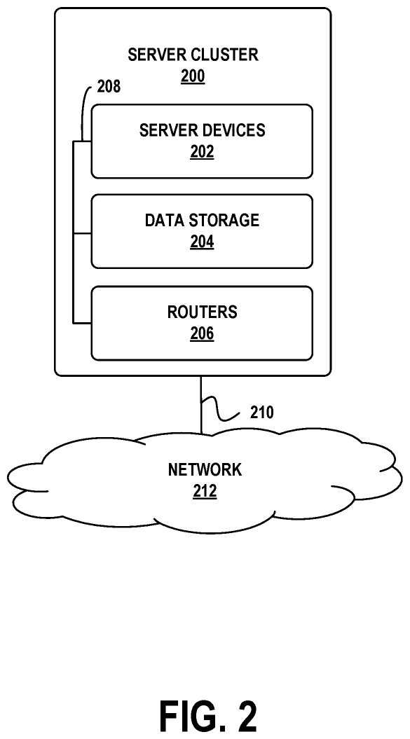

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

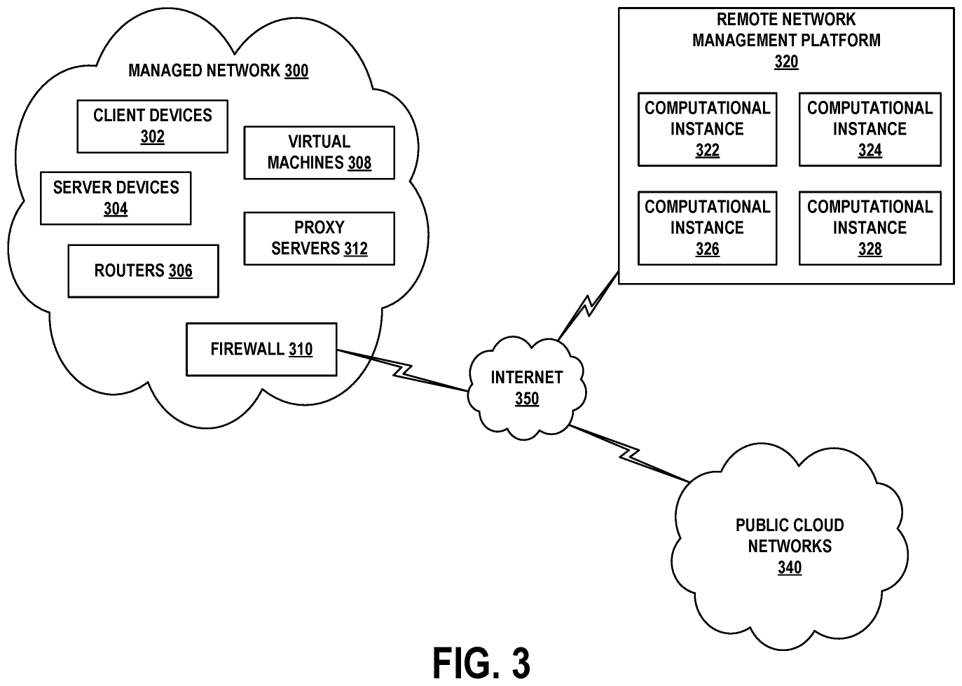

FIG. 3 depicts a remote network management architecture, in accordance with example embodiments. This architecture includes three main components-managed network 300, remote network management platform 320, and public cloud networks 340-all connected by way of Internet 350.
A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.
B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.
C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.
D. Communication Support and Other Operations

Internet 350 may represent a portion of the global Internet. However, Internet 350 may alternatively represent a different type of network, such as a private wide-area or local-area packet-switched network.

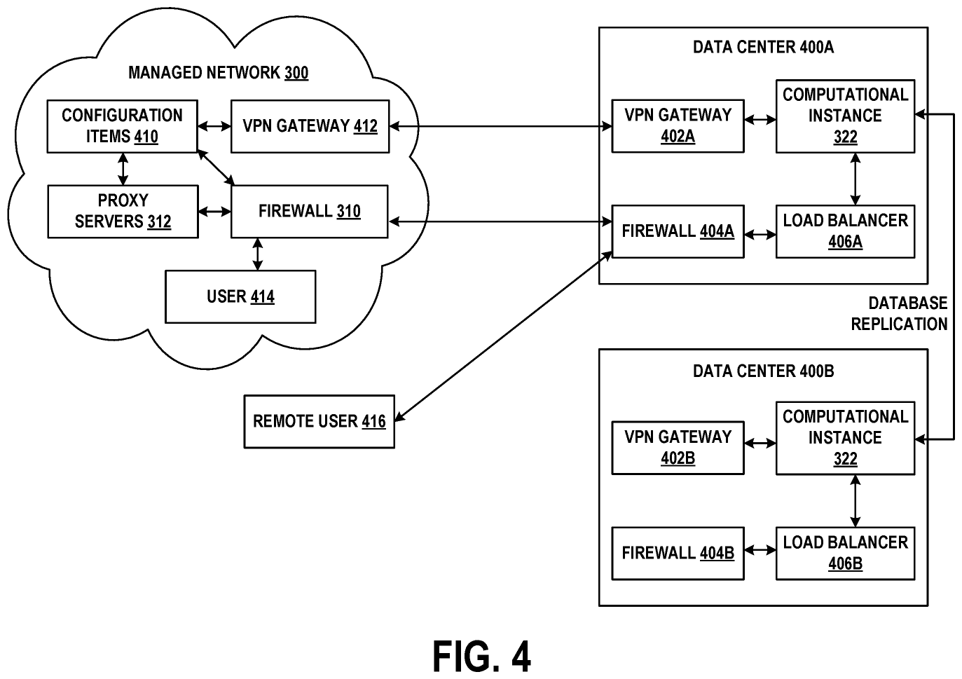

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

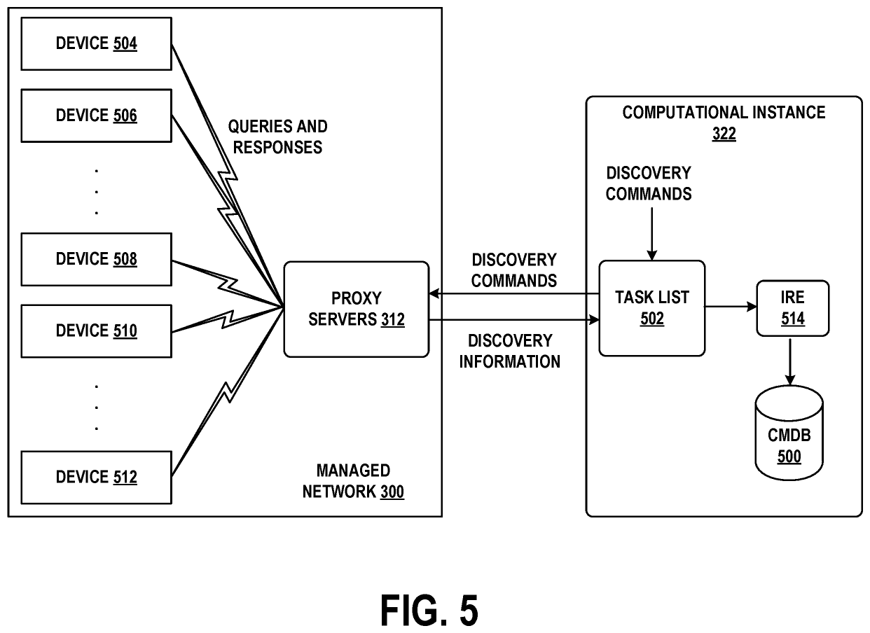

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.
A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.
B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.
C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Example Application Generation

It is desirable to represent common activities, actions, functions, or other operations on a managed network or other technological system as reusable ‘capabilities.’ This can allow more complex ‘applications’ to be composed more easily from such capabilities, allows such capabilities to be stored using less storage space (by, e.g., referencing the component capabilities and their integration into the application, rather than by copying the complete code or other configuration information for the capabilities into every application that includes relevant capabilities), and also allows sets of applications to be more easily updated by updating the relevant capabilities, thereby also updating any applications that include the updated capabilities.

However, even for small numbers of capabilities, the space of possible applications composed therefrom can be very large. Thus, it can be computationally expensive to enumerate all of the possible applications for a given set of capabilities, and expensive to store representations of such large sets of applications for later reference and use. Further, identifying a relevant application (or set of relevant applications) based on a user's stated need (e.g., a search query) can be expensive for such a large sample of possible applications, as well as resulting in over-or under-inclusive search results.

Instead, the embodiments described herein generate applications, from constituent capabilities, in response to and based on specific user requests. The embodiments described herein result in functional applications that correspond well to user-requested application functionality while also accomplishing such ends using reduced computational cost. This is accomplished by using a large language model (LLM) or other generative machine learning model to identify, from a set of possible capabilities based on a user input, the identity, number, and other properties of capabilities to compose together to arrive at an application that satisfies the request or other constraints represented by the user input. A graphing function is then applied to the set of identified capabilities to order the identified capabilities based on their dependencies. The identified capabilities can then be executed, in the order specified by the graphing function and using any inputs or configuration parameters specified by the machine learning model, to execute the application.

An LLM is an advanced computational model, primarily functioning within the domain of natural language processing (NLP) and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

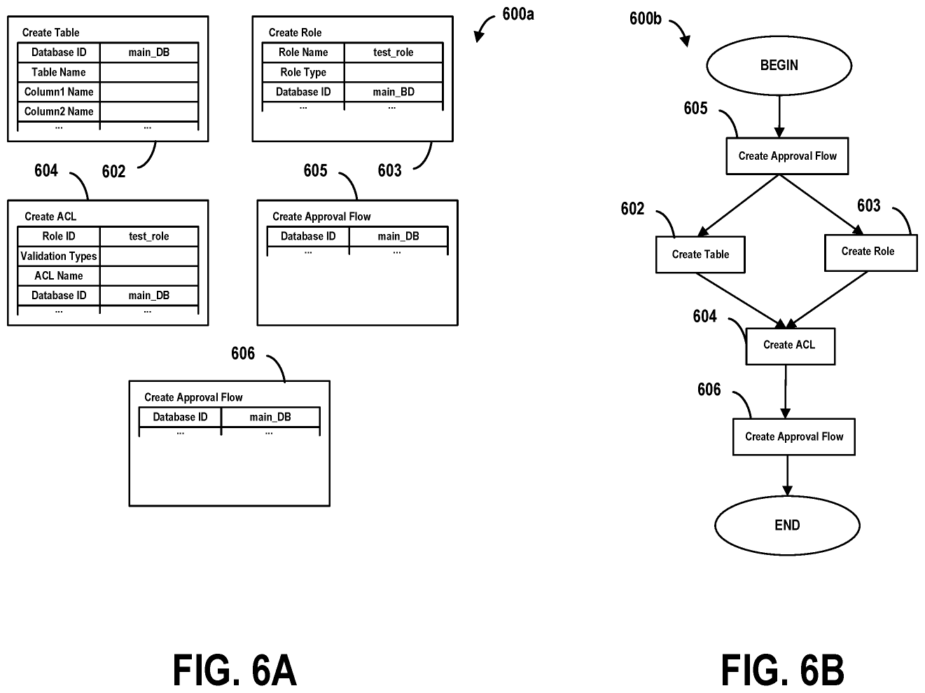

FIG. 6A illustrates aspects of a set of capabilities 600a (“Create Table” 602, “Create Role” 603, “Create Role” 604, etc.) that have been identified based on the output of a machine learning model that has been presented with the user input “I want to create an application with two tables with ACLs on both of the tables. For the ACLs, use a new role test_role. Create an approval flow for the second table” according to the embodiments described herein. As shown, the model output can identify multiple different instances of the same capability for use in a single application (e.g., two instances of “Create Approval Flow” 605, 606). The model output can also represent some or all of the inputs and/or configuration parameters of one or more of the identified capabilities, where such information is explicitly or implicitly available in the user input and/or the context of the task. For example, the example user input specifies that the “new role” should have the name “test_role,” and so the model output specifies that input “Role Name” of the capability “Create Role” 603 should be “test_role.” Additionally, the model was able to infer from context that the database with which the various capabilities should interact (the “Database ID” configuration parameter) has the ID “main_DB” (e.g., inferred from the context that the user who generated the user input is associated with the “main_DB” database).

Instructing and/or training the machine learning model to provide an output indicative of such input or configuration parameter information can lead to reduced computational cost to generate the application, since the graphing function can avoid considering inputs/configuration parameters that are already ‘known’ when determining the graph of dependencies between the identified capabilities. Additionally, execution of the application can be sped up by avoiding consulting the user for inputs/configuration parameters that have already been provided and/or that can be inferred from the user input or other available information (e.g., context information about the user, the user's history, and/or about the systems that the user has access to and/or regularly interacts with). Where such user interactions implicate the use of a machine learning model (e.g., to compose queries and to parse the user responses thereto), operating the model to provide outputs indicative of input or configuration parameter information can also reduce the computational cost of executing the application by avoiding one or more instances of execution of the model to facilitate such user interactions.

Once the capabilities have been identified by the model output, a graphing function can be applied to the capabilities to determine the ordering of execution of the capabilities within the application requested by the user input. FIG. 6B depicts the result of such a graphing function, showing dependencies 600b between the execution of the various capabilities and thus directing the execution of the capabilities when executing the application. Such dependencies can include a capability receiving, as an input, an output of another capability (e.g., the “Create Role” 603 capability outputting the name, UUID, or other identifying information about the role created thereby and the “Create ACL” 604 capability receiving that output as an input in order to generate an access control list therefor). Such dependencies can also include a capability relying on the completion of a database manipulation or other ‘remote’ task by another capability (e.g., the “Create ACL” 604 capability creating an access control list table in the “main_DB” for which an approval flow is subsequently created by the latter “Create Approval Flow” 606 capability). Such a graph prevents failed execution of the application by avoiding out-of-order execution of the capabilities, e.g., executing a capability that requires an output or effect of a second capability prior to execution of the second capability.

The use of this combination of machine learning model and graphing function allows the machine learning model to be less computationally expensive to run (e.g., by having a shorter history, by having fewer parameters) and/or to be run fewer times while still resulting in executable applications that accurately affect the intent represented by the user input. For example, a single machine learning model could be used to generate the application, including a representation of the dependencies between a set a selected capabilities; however, such a single model would be more likely to generate non-executable applications and/or to exhibit hallucinations. These shortcomings could be reduced by expanding the size of the model and/or separating the application generation process into multiple uses of the model; however, these solutions incur a significant penalty with respect to computational cost (cycles, memory, interconnect bandwidth, storage) relative to the embodiments described herein.

Capabilities can include a wide variety of programs, functions, database schemas, scripts, executable code snippets, user interfaces, credentialing activities, database function calls, API calls, account generation actions, configuration data, database tables, or other operations related to a managed network or other technological system. Capabilities can have inputs and/or outputs; outputs of some capabilities may be used as inputs to and/or configuration parameters of other capabilities within an application composed of the capabilities. In such examples, the capabilities that receive inputs from other capabilities would be located ‘downstream’ from those other capabilities in the graph of the capabilities.

Capabilities can also have effects that are not ‘local’ to the other capabilities of an application. For example, a capability could have the effect of modifying information in a database, creating a new table in a database, modifying a user credential, modifying a level of access or authorization of a user or other entity, creating a new role, user account, or other element in a database, or making some other modification to a database or other technological system. In some examples, the completion of such modifications could be required for the performance of other capabilities in an application. For example, the creation of a new role could be required in order for an access control list (ACL) to be created for the new role. In such examples, a capability (e.g., a capability to create an ACL for a new role) that depends on the effects of another capability (e.g., a capability that creates the new role) would be located ‘downstream’ from the other capability in the graph of the capabilities.

Using a machine learning model (e.g., an LLM) to identify, from a set of possible capabilities based on a user input, the identity, number, and other properties of capabilities to compose into an application can include applying, to the machine learning model, the user input and information that is representative of the set of available capabilities in a database. Such representative information can include a summary or other textual description of the capabilities, a function prototype or other representation of the inputs and/or outputs of the capability, a prototype API call, or other information about the capabilities. Providing information about the capabilities in such a manner (e.g., as text provided to an input of an LLM or other machine learning model) allows user-created capabilities (or other ‘additional’ capabilities) to be easily added to ‘stock’ capabilities in the database based merely on what descriptive information is available (e.g., summaries or other textual descriptions of the capabilities that a user can easily generate). This avoids, e.g., re-training the machine learning model, using technician time to fine-tune descriptor information for the capabilities, or other more costly options to expand the set of capabilities available for composing into applications.

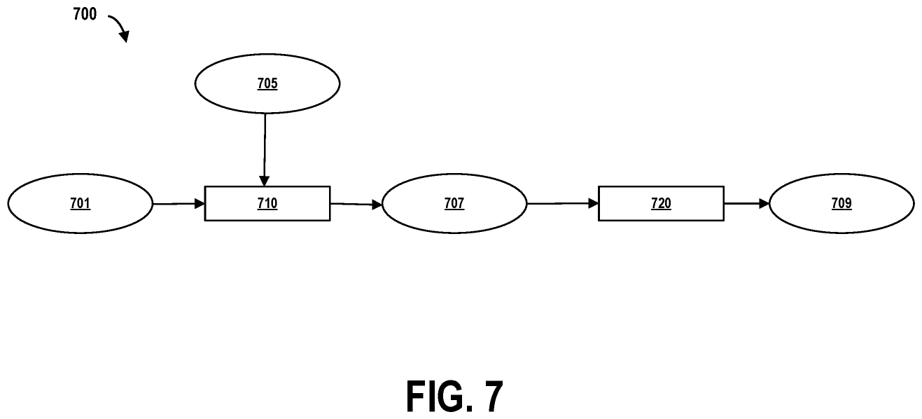

FIG. 7 depicts aspects of such a process 700. A user input 701 is obtained used to generate 710 a model input 707. The model input 707 is then applied to a machine learning model 720 to generate a model output 709 that identifies, from a set of possible capabilities, the identity, number, and other properties of capabilities to compose into an application. As shown, the process 710 to generate the model input 707 from the user input 701 can also receive auxiliary information 705, e.g., a summary or other textual description of the available capabilities, a function prototype or other representation of the inputs and/or outputs of the capability, a prototype API call, or other information about the capabilities from which the model 720 can select capabilities to compose into an application that satisfies a request present in the user input 701. The process 710 to generate the model input 707 can include concatenating such information sources with the user input 701 and other text or other information to generate a prompt. For example, various static prompts could be concatenated with the user input 701 and the auxiliary information 705 to form the model input 707. Such prompt portions of the model input 707 could include text specifying a tone or role for the model 720 to assume or apply to the output, a formatting for the model 720 to apply to the output, text indicating that a certain portion of the auxiliary information 705 represents information about available capabilities and that another portion of the auxiliary information 705 represents past user inputs, past model 720 outputs, user credentials, or other context information, or some other prompt information. The process 710 to generate the model input 707 can include performing some level of processing on the user input 701, e.g., removing irrelevant portions of the user input, tokenizing the user input 701, converting numbers or other numerical or categorical references in the user input 701 into a standard or simplified format, or performing some other processing on the user input 701 before generating the model input 707 in part therefrom.

The input 707 provided to the machine learning model 720 could also include other ‘context’ information (e.g., provided as part of the auxiliary information 705). Such context information could include information about the requesting user and/or their history of queries (e.g., the user's access level, the user's title or function within an organization, a history of past user queries and/or information about applications previously generated for the user). In some examples, the set of capabilities available to a particular user may be keyed to the user's identity (e.g., to a subscription status of the user, to an authorization level of the user); in such examples, the set of information representative of the capabilities that is presented as input to the machine learning model could be restricted to those capabilities to which the user has access.

The set of available capabilities could be pre-filtered in order to reduce the computational cost of executing the machine learning model to identify which capabilities to use to compose an application. By filtering a set of available capabilities to a subset of capabilities that are more relevant to a user input, the amount of information about the capabilities that is presented as input to a machine learning model (e.g., descriptive text, function calls) can be reduced. Such filtering could be done in a variety of ways, e.g., via a semantic search to identify, from a larger set of available capabilities, a preliminary subset of capabilities that are semantically similar to a user input. Performing such a semantic search could include, e.g., determining an embedding vector that represents the user input in a multi-dimensional semantic space (e.g., the embedding vector could be a paragraph vector). The user input embedding vector could then be compared to embedding vectors for the available capabilities, e.g., by determining distances or angles therebetween in the semantic space. Such comparisons could be used to identify the preliminary subset of capabilities (e.g., the top n capabilities with respect to semantic similarity, the capabilities whose similarity is greater than a threshold similarity level) that are semantically similar to the user input. The embeddings of the available capabilities could be determined by, e.g., determining paragraph vectors or other embeddings of the summaries, descriptions, function calls, and/or other information representative of the capabilities in the multi-dimensional semantic space.

As noted above, the model output may include indications of inputs and/or configuration parameters of the selected capabilities. To execute a generated application, the selected capabilities can be executed in an order, according to the graph of the application, with the output-indicated inputs and/or configuration parameters filled in according to the model output. Additionally or alternatively, a machine learning model (e.g., the same model as was used to identify the capabilities during the application generation process, or a different machine learning model) could be used to execute the capabilities, with the output of the model indicating the content of the inputs and/or configuration parameters of the capabilities. The input to such a model could include the original user input used to generate the application, as well as context or other information. For example, the input to the model could include a description or other information about the capability being executed, as well as portions of the original model output related thereto (e.g., portions of the original model output that are indicative of the values of inputs or configuration parameters of the capability). Such context input could also include any user inputs received subsequent to the original user input, e.g., user responses to queries generated by previous executions of the model. This can allow execution of the capabilities to be performed more quickly and/or with a lower computational cost by ‘remembering’ execution-related information (e.g., inputs, configuration parameters) that have already been expressly stated by the user previously and/or that can be confidently inferred from the set of prior user inputs.

Using a machine learning model to execute a capability can include providing information about the capability (e.g., a description of the capability, an image of a user interface of the capability, HTML or other code representing a user interface of the capability, a command line or other textual interaction with the capability) as well as other information (e.g., the user input that resulted in the generation of the application, context information) to generate an output. The output can indicate an action to be taken, which can include interacting with the capability (e.g., providing an input or command to the capability, filling a field, pressing a button, or interacting with another element of a user interface) and/or providing a query for additional information to the user (e.g., a query for an input or configuration parameter that is needed to continue execution of the capability). User response(s) to such queries can then be applied to the model (e.g., by extending the historical context provided to the model to include the newly-obtained user response(s)) and used to generate further model outputs, which may indicate further actions (e.g., to interact with the capability, to query the user again for additional information). By retaining past user responses and other context data, and providing such information as part of the input to the machine learning model, the overall time and computational cost of executing an application can be reduced. This is because past user responses may, individually or in aggregate, be sufficient to determine inputs and/or configuration parameters to the capabilities as they are executed, thereby avoiding the time and computational cost attendant on using the model to generate a query, providing the query to a user, receiving the user's response to the query, and applying the user's response to the model to generate an output that is indicative of future action(s) with respect to the execution of the application and/or providing further queries to the user.

### VII. Example Technical Improvements

These embodiments provide a technical solution to a technical problem. One technical problem being solved is the computational and data storage costs to generate and store the different applications that can be composed from a set of available capabilities. Even a small number of capabilities results in a combinatorically large number of possible applications, and correspondingly large computational costs to generate such a large number of applications, data storage costs to store representations thereof, and additional computational costs to search the set of generated applications to return one or more relevant applications in response to user input. Instead, the embodiments described herein allow applications to be generated individually, in response to specific user inputs and adapted to the specific requests and context represented by such user inputs. Additionally, the computational cost of generating functional, accurate applications based on such user inputs is reduced by separating the application development process into two steps: a first step wherein a machine learning model identifies, from a set of available capabilities based on the user input, a set of capabilities to compose into the requested application; and a second step wherein a graphing function determines the dependencies between the identified capabilities. This allows an application to be generated that can be executed without errors due to out-of-order execution of the capabilities (due to the graph generated by the graphing function) but that can also be generated using a smaller or otherwise lower-cost machine learning model (due to the output of the model not needing to include accurate dependency information and/or the model not needing to be executed multiple times to, e.g., identify capabilities in a first execution and specify order of execution in a second).

The embodiments described herein also provide reduced overall computational cost and total elapsed time when executing an application by using a machine learning model to execute the capabilities and providing, to that model, accumulated context information from prior user interactions. In this way, the model can infer, from the context information, inputs or configuration parameters needed for execution of the capability without an additional user interaction. This can avoid the time and other costs of such an interaction. This can also avoid the cost of additional model executions, e.g., when the model is used to generate queries to be presented to the user and to interpret user responses thereto in order to continue capability execution.

Other technical improvements may also flow from these embodiments, and other technical problems may be solved. Thus, this statement of technical improvements is not limiting and instead constitutes examples of advantages that can be realized from the embodiments.

### VIII. Example Operations

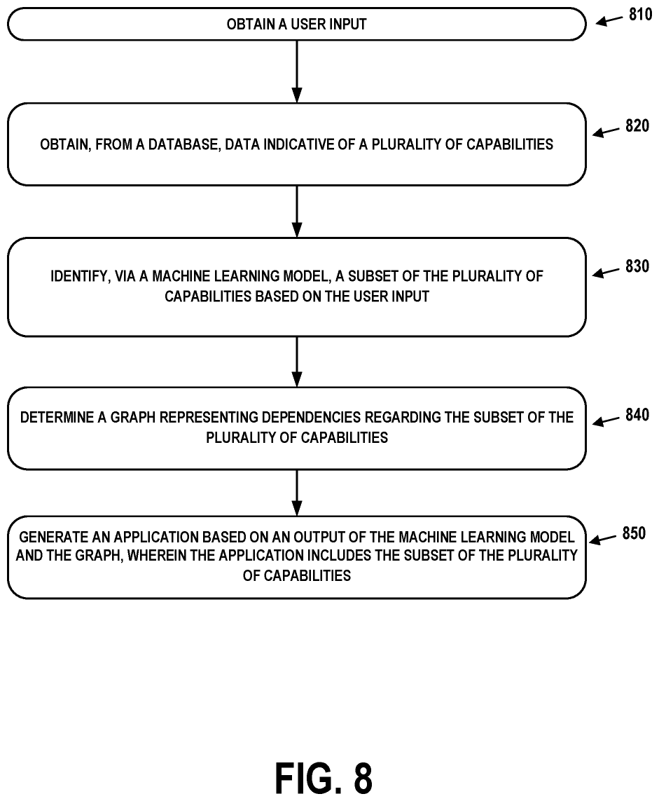

FIG. 8 is a flow chart illustrating an example embodiment. The process illustrated by FIG. 8 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 8 may be simplified by the removal of any one or more of the features shown therein. Further, these embodiments may be combined with features, aspects, and/or implementations of any of the previous figures or otherwise described herein.

The embodiments of FIG. 8 include obtaining a user input (810). The user input can include information relating to at least one input or configuration parameter of one of the subset of the plurality of capabilities, and identifying the plurality of capabilities can include applying the user input to the machine learning model to generate an additional model output that identifies the subset of the plurality of capabilities and that also indicates the at least one input or configuration parameter of the one of the subset of the plurality of capabilities.

The embodiments of FIG. 8 also include obtaining, from a database, data indicative of a plurality of capabilities (820). The plurality of capabilities can include a user-generated capability, the data indicative of the user-generated capability in the database can include a textual description of a function of the user-generated capability, and identifying the plurality of capabilities can include: (i) applying, to the machine learning model, the user input and the textual description of the function of the user-generated capability to generate an additional model output; and (ii) based on the additional model output, identifying the subset of the plurality of capabilities. Identifying the plurality of capabilities can include: (i) applying, to the machine learning model, the user input and textual descriptions of functions of the plurality of capabilities to generate an additional model output; and (ii) based on the additional model output, identifying the subset of the plurality of capabilities.

The embodiments of FIG. 8 further include identifying, via a machine learning model, a subset of the plurality of capabilities based on the user input (830). Identifying the plurality of capabilities (830) may include: (i) performing a semantic search to identify a preliminary set of the plurality of capabilities that are semantically similar to the user input; (ii) applying, to the machine learning model, the user input and a representation of the preliminary set of capabilities to generate an additional model output; and (iii) based on the additional model output, identifying the subset of the plurality of capabilities. In such embodiments, applying, to the machine learning model, the user input and the representation of the preliminary set of capabilities to generate the additional model output can include applying, to the machine learning model, textual descriptions of functions of the preliminary set of capabilities. Performing the semantic search to identify the preliminary set of capabilities could include: (i) determining an embedding of the user input in a multi-dimensional semantic space; and (ii) comparing the embedding of the user input in the multi-dimensional semantic space to embeddings, in the multi-dimensional semantic space, that represent respective capabilities of the plurality of capabilities to identify the preliminary set of the plurality of capabilities whose embeddings are near the embedding of the user input in the multi-dimensional semantic space.

The embodiments of FIG. 8 additionally include determining a graph representing dependencies regarding the subset of the plurality of capabilities (840). The graph representing dependencies regarding the subset of the plurality of capabilities may represent every capability of the subset of capabilities as at least one of a dependency for at least one other capability or dependent upon at least one other capability.

The embodiments of FIG. 8 also include generating an application based on an output of the machine learning model and the graph, wherein the application includes the subset of the plurality of capabilities (850).

The embodiments of FIG. 8 may include additional or alternative steps or features. For example, the embodiments of FIG. 8 may include executing the application. Executing the application can include: (i) for a particular capability of the subset of the plurality of capabilities, obtaining, from a user that supplied the user input, at least one input or configuration parameter of the particular capability; and (ii) executing the particular capability based on the at least one input or configuration parameter. Obtaining the at least one input or configuration parameter can include: (i) applying the machine learning model or a further machine learning model to the particular capability to generate a first additional model output that represents a query regarding the at least one input or configuration parameter; (ii) presenting the user with the query; and (iii) receiving, from the user in response to the query, a user response, and executing the particular capability can include: (i) applying the user response to the machine learning model or the further machine learning model to generate a second additional model output; and (ii) executing the particular capability based on the second additional model output. executing the application can additionally include: (i) applying the machine learning model or further machine learning model to a second capability to generate a third additional model output that is indicative of at least one input or configuration parameter of the second capability, wherein applying the machine learning model or further machine learning model to the second capability comprises applying, to the machine learning model or further machine learning model, context information that includes the user input and the user response, and wherein the context information includes information sufficient to infer the at least one input or configuration parameter of the second capability; and (ii) executing the second capability based on the third additional model output.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a user input;
obtaining, from a database, data indicative of a plurality of capabilities;
identifying, via a machine learning model, a subset of the plurality of capabilities based on the user input;
determining a graph representing dependencies regarding the subset of the plurality of capabilities; and
generating an application based on an output of the machine learning model and the graph, wherein the application includes the subset of the plurality of capabilities.

2. The method of claim 1, wherein identifying the plurality of capabilities comprises:
performing a semantic search to identify a preliminary set of the plurality of capabilities that are semantically similar to the user input;
applying, to the machine learning model, the user input and a representation of the preliminary set of capabilities to generate an additional model output; and
based on the additional model output, identifying the subset of the plurality of capabilities.

3. The method of claim 2, wherein performing the semantic search to identify the preliminary set of capabilities comprises:
determining an embedding of the user input in a multi-dimensional semantic space; and
comparing the embedding of the user input in the multi-dimensional semantic space to embeddings, in the multi-dimensional semantic space, that represent respective capabilities of the plurality of capabilities to identify the preliminary set of the plurality of capabilities whose embeddings are near the embedding of the user input in the multi-dimensional semantic space.

4. The method of claim 2, wherein applying, to the machine learning model, the user input and the representation of the preliminary set of capabilities to generate the additional model output comprises applying, to the machine learning model, textual descriptions of functions of the preliminary set of capabilities.

5. The method of claim 1, wherein the plurality of capabilities comprise a user-generated capability, wherein data indicative of the user-generated capability in the database includes a textual description of a function of the user-generated capability, and wherein identifying the plurality of capabilities comprises:
applying, to the machine learning model, the user input and the textual description of the function of the user-generated capability to generate an additional model output; and
based on the additional model output, identifying the subset of the plurality of capabilities.

6. The method of claim 1, wherein the user input includes information relating to at least one input or configuration parameter of one of the subset of the plurality of capabilities, and wherein identifying the plurality of capabilities comprises applying the user input to the machine learning model to generate an additional model output that identifies the subset of the plurality of capabilities and that also indicates the at least one input or configuration parameter of the one of the subset of the plurality of capabilities.

7. The method of claim 1, further comprising:
executing the application.

8. The method of claim 7, wherein executing the application comprises:
for a particular capability of the subset of the plurality of capabilities, obtaining, from a user that supplied the user input, at least one input or configuration parameter of the particular capability; and
executing the particular capability based on the at least one input or configuration parameter.

9. The method of claim 8, wherein obtaining the at least one input or configuration parameter comprises:
applying the machine learning model or a further machine learning model to the particular capability to generate a first additional model output that represents a query regarding the at least one input or configuration parameter;
presenting the user with the query; and
receiving, from the user in response to the query, a user response, and wherein executing the particular capability comprises:
applying the user response to the machine learning model or the further machine learning model to generate a second additional model output; and
executing the particular capability based on the second additional model output.

10. The method of claim 9, wherein executing the application additionally comprises:
applying the machine learning model or further machine learning model to a second capability to generate a third additional model output that is indicative of at least one input or configuration parameter of the second capability, wherein applying the machine learning model or further machine learning model to the second capability comprises applying, to the machine learning model or further machine learning model, context information that includes the user input and the user response, and wherein the context information includes information sufficient to infer the at least one input or configuration parameter of the second capability; and
executing the second capability based on the third additional model output.

11. The method of claim 1, wherein identifying the plurality of capabilities comprises:
applying, to the machine learning model, the user input and textual descriptions of functions of the plurality of capabilities to generate an additional model output; and
based on the additional model output, identifying the subset of the plurality of capabilities.

12. The method of claim 1, wherein the graph representing dependencies regarding the subset of the plurality of capabilities represents every capability of the subset of capabilities as at least one of a dependency for at least one other capability or dependent upon at least one other capability.

13. A non-transitory computer-readable medium, having stored thereon program instructions that, upon execution by a computing system, cause the computing system to perform operations comprising:
obtaining a user input;
obtaining, from a database, data indicative of a plurality of capabilities;
identifying, via a machine learning model, a subset of the plurality of capabilities based on the user input;
determining a graph representing dependencies regarding the subset of the plurality of capabilities; and
generating an application based on an output of the machine learning model and the graph, wherein the application includes the subset of the plurality of capabilities.

14. The non-transitory computer-readable medium of claim 13, wherein identifying the plurality of capabilities comprises:
performing a semantic search to identify a preliminary set of the plurality of capabilities that are semantically similar to the user input;
applying, to the machine learning model, the user input and a representation of the preliminary set of capabilities to generate an additional model output; and
based on the additional model output, identifying the subset of the plurality of capabilities.

15. The non-transitory computer-readable medium of claim 13, wherein the user input includes information relating to at least one input or configuration parameter of one of the subset of the plurality of capabilities, and wherein identifying the plurality of capabilities comprises applying the user input to the machine learning model to generate an additional model output that identifies the subset of the plurality of capabilities and that also indicates the at least one input or configuration parameter of the one of the subset of the plurality of capabilities.

16. The non-transitory computer-readable medium of claim 13, wherein the operations further comprise:
executing the application, wherein executing the application comprises: (i) for a particular capability of the subset of the plurality of capabilities, obtaining, from a user that supplied the user input, at least one input or configuration parameter of the particular capability; and (ii) executing the particular capability based on the at least one input or configuration parameter
wherein obtaining the at least one input or configuration parameter comprises: (i) applying the machine learning model or a further machine learning model to the particular capability to generate a first additional model output that represents a query regarding the at least one input or configuration parameter; (ii) presenting the user with the query; and (iii) receiving, from the user in response to the query, a user response,
and wherein executing the particular capability comprises: (i) applying the user response to the machine learning model or the further machine learning model to generate a second additional model output; and (ii) executing the particular capability based on the second additional model output.

17. A system comprising:
one or more processors; and
memory, containing program instructions that, upon execution by the one or more processors, cause the system to perform operations comprising:
obtaining a user input;
obtaining, from a database, data indicative of a plurality of capabilities;
identifying, via a machine learning model, a subset of the plurality of capabilities based on the user input;
determining a graph representing dependencies regarding the subset of the plurality of capabilities; and
generating an application based on an output of the machine learning model and the graph, wherein the application includes the subset of the plurality of capabilities.

18. The system of claim 17, wherein identifying the plurality of capabilities comprises:
performing a semantic search to identify a preliminary set of the plurality of capabilities that are semantically similar to the user input;
applying, to the machine learning model, the user input and a representation of the preliminary set of capabilities to generate an additional model output; and
based on the additional model output, identifying the subset of the plurality of capabilities.

19. The system of claim 17, wherein the user input includes information relating to at least one input or configuration parameter of one of the subset of the plurality of capabilities, and wherein identifying the plurality of capabilities comprises applying the user input to the machine learning model to generate an additional model output that identifies the subset of the plurality of capabilities and that also indicates the at least one input or configuration parameter of the one of the subset of the plurality of capabilities.

20. The system of claim 17, wherein the operations further comprise:
executing the application, wherein executing the application comprises: (i) for a particular capability of the subset of the plurality of capabilities, obtaining, from a user that supplied the user input, at least one input or configuration parameter of the particular capability; and (ii) executing the particular capability based on the at least one input or configuration parameter
wherein obtaining the at least one input or configuration parameter comprises: (i) applying the machine learning model or a further machine learning model to the particular capability to generate a first additional model output that represents a query regarding the at least one input or configuration parameter; (ii) presenting the user with the query; and (iii) receiving, from the user in response to the query, a user response,
and wherein executing the particular capability comprises: (i) applying the user response to the machine learning model or the further machine learning model to generate a second additional model output; and (ii) executing the particular capability based on the second additional model output.
